(19) United States
(12) Patent Application Publication
(10) Pub. No.: US 2014/0343993 A1
(43) Pub. Date: Nov. 20, 2014

(54) ELECTRONIC DEVICE AND METHOD FOR SCHEDULING CALENDAR EVENTS IN ELECTRONIC CALENDAR

(71) Applicant: HON HAI PRECISION INDUSTRY CO., LTD., New Taipei (TW)

(72) Inventor: CHIH-CHIEN CHENG, New Taipei (TW)

(73) Assignee: HON HAI PRECISION INDUSTRY CO., LTD., New Taipei (TW)

(21) Appl. No.: 14/278,019

(22) Filed: May 15, 2014

(30) Foreign Application Priority Data
May 17, 2013 (TW) 102117567

(51) Int. Cl. G06Q 10/10

(52) U.S. Cl. CPC G06Q 10/1095
USPC 705/7.19

(57) ABSTRACT

In a method for scheduling calendar events in an electronic calendar of an electronic device, a schedule operational menu is generated in an electronic calendar of the electronic device when the electronic calendar is open. Subject information of a calendar event is searched from a storage device of the electronic device when a the calendar item of the schedule operational menu is selected, and a date of the calendar event is determined in the electronic calendar. The subject information of the calendar event is displayed on a date column of the electronic calendar, and the subject information of the calendar event is hidden from the date column of the electronic calendar when the calendar item is unselected.

### FIELD

The present disclosure relates to a calendar events management system and method, and particularly to an electronic device and a method for scheduling calendar events in an electronic calendar.

### BACKGROUND

Electronic calendars are increasingly used to organize schedules, agendas and meetings. Such calendars can be accessed from both desktop computers and portable computing devices, such as laptop computers, personal digital assistants (PDAs), mobile phones, and wearable computers. In today's work environment it is quite normal for members of an organization to have a plurality of calendar events (for example, agendas or meetings) every day throughout the year.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a calendar scheduling system.

FIG. 2 is a block diagram illustrating an example function modules of a calendar scheduling system of FIG. 1.

FIG. 3 is a flowchart of an example embodiment of a method for scheduling calendar events in an electronic calendar.

FIG. 4 is a schematic diagram of an example embodiment of scheduling calendar events in the electronic calendar.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

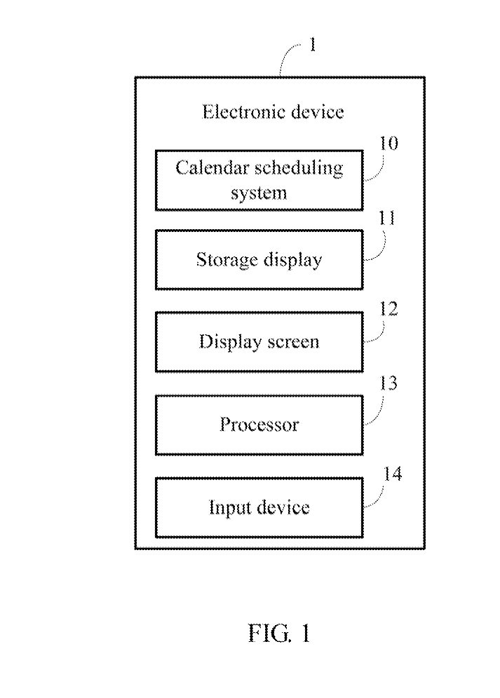

FIG. 1 illustrates a block diagram of an example embodiment of a calendar scheduling system 10. In the embodiment, the calendar scheduling system 10 is implemented by an electronic device 1. The electronic device 1 comprises, but is not limited to, a storage device 11, a display screen 12, at least one processor 13, and an input device 14. In one embodiment, the electronic device 1 can be a desktop computer or a portable computing device, such as a laptop computer, a personal digital assistant (PDA), a mobile phone, and a wearable computer. The calendar scheduling system 10 can comprise computerized instructions in the form of one or more computer-readable programs which can be stored in the storage device 11 and executed by the at least one processor 13. FIG. 1 illustrates only one example of the electronic device 1, and other examples can comprise more or fewer components than those shown in the embodiment, or have a different configuration of the various components.

The storage device 11 stores an electronic calendar 120, a plurality of calendar events, and subject information of the calendar events. The calendar events include, but is not limited to, schedules, agendas and meetings. Each of the calendar events can correspond to a specified date. For example, a user can set a calendar event, for example a meeting on May 6, 2013, and also set the calendar event on May 15, 2003. The subject information of the calendar event is set as a meeting of a company at 8 a.m. on May 6, 2013, or a meeting of the company at 3 p.m. on May 15, 2013. The display screen 12 is a touch sensitive screen that displays the electronic calendar 120 and the subject information of the calendar events. The input device 14 is a keypad or a mouse that can be used for manual operations for scheduling the calendar events on the electronic calendar 120.

In one embodiment, the storage device 11 can be an internal storage system, such as a flash memory, a random access memory (RAM) for temporary storage of information, and/or a read-only memory (ROM) for permanent storage of information. The storage device 11 can also be an external storage system, such as an external hard disk, a storage card, or a data storage medium. The at least one processor 13 can be a central processing unit (CPU), a microprocessor, or other suitable data processor chip that performs various functions of the electronic device 1.

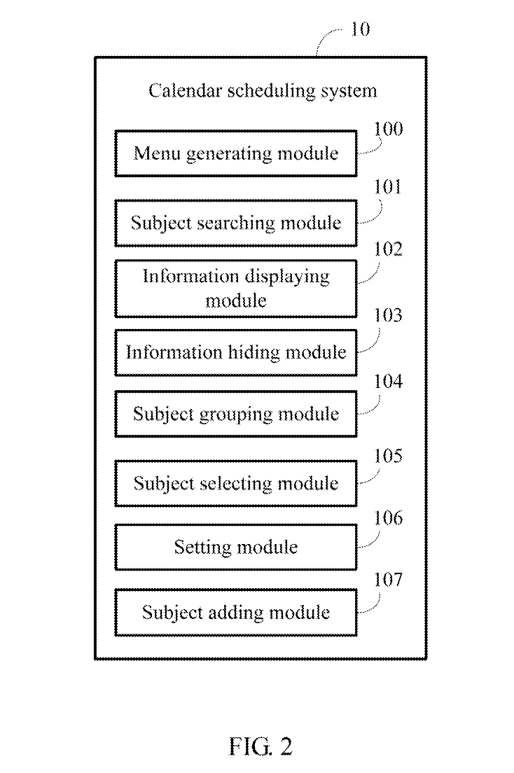

FIG. 2 is a block diagram illustrating an example function modules of an calendar scheduling system 10. In an example embodiment, the calendar scheduling system 10 comprises, but is not limited to, a menu generating module 100, a subject searching module 101, an information displaying module 102, an information hiding module 103, a subject grouping module 104, a subject selecting module 105, a setting module 106, and a subject adding module 107. Modules 100-107 can comprise computerized instructions in the form of one or more computer-readable programs that can be stored in a non-transitory computer-readable medium, for example the storage device 11, and executed by the at least one processor 13 of the electronic device 1.

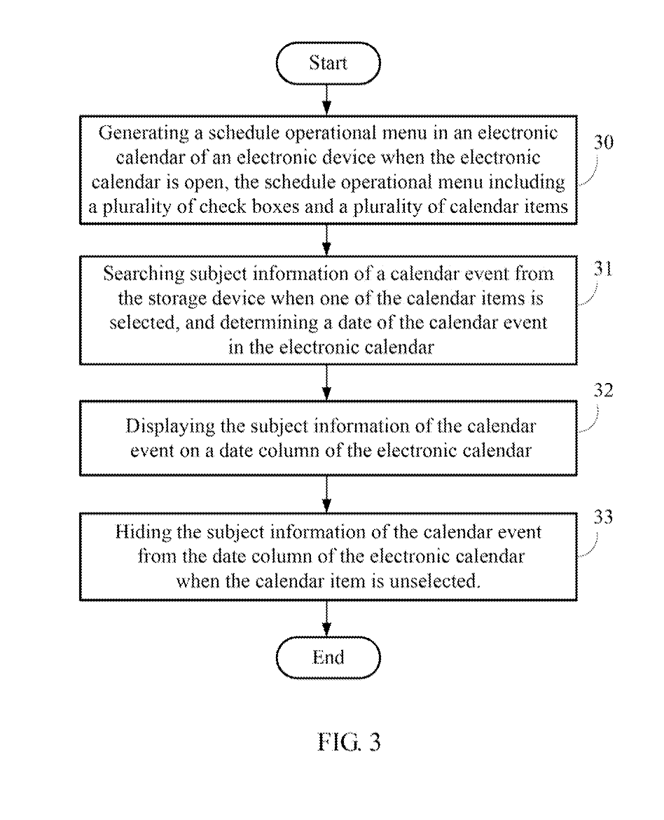

FIG. 3 illustrates a flowchart of an example embodiment of a method for scheduling calendar events in an electronic calendar of an electronic device. In an example embodiment, the method is performed by execution of computer-readable software program codes or instructions by the at least one processor 13 of the electronic device 1. Depending on the embodiment, additional steps may be added, others removed, and the ordering of the steps may be changed.

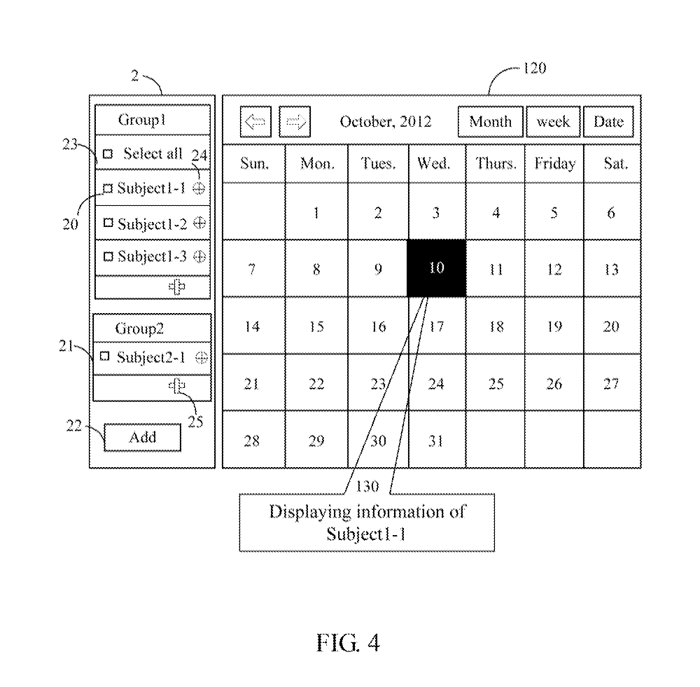

In step 30 and referring to FIG. 4, the menu generating module 100 generates a schedule operational menu 2 in the electronic calendar 120 when the electronic calendar 120 is open. Referring to FIG. 4, the schedule operational menu 2 includes a plurality of check boxes 20 and a plurality of calendar items 21. Each of the calendar items 21 can have a subject of a calendar event that corresponds to a check box 20. Each of the check box 20 can be selected by the user through the input device 14. If the check box 20 is selected, a calendar event corresponding to the check box 20 is enabled. If the check box 20 is unselected, the calendar event corresponding to the check box 20 is disabled. In one example embodiment, the calendar event, for example Subject1-1, is enabled when the check box 20 corresponding to Subject1-1 is selected, and the calendar event, for example Subject1-1, is disabled when the check box 20 corresponding to Subject1-1 is unselected.

In step 31 and referring to FIG. 4, the subject searching module 101 searches for subject information of a calendar event from the storage device 11 when one of the calendar items 21 is selected, and determines a date of the calendar event in the electronic calendar 120. The subject information of the calendar item 21, for example Subject1-1, are searched from the storage device 11 when the calendar item 21, for example Subject1-1, has been selected, and the date of the calendar event is determined as Oct. 10, 2010.

In step 32 and referring to FIG. 4, the information displaying module 102 displays the subject information of the calendar event on a date column 130 of the electronic calendar 120. In one example embodiment, the subject information of the calendar event is a meeting of a company at 8 a.m. on Oct. 10, 2012, the information of the meeting can be displayed on the date column 130 of the electronic calendar 120 when the calendar item 21, for example Subject1-1 has been selected.

In step 33 and referring to FIG. 4, the information hiding module 103 hides the subject information of the calendar event from the date column 130 of the electronic calendar 12 when the calendar item 21 is unselected. The subject information of the meeting, for example a meeting of a company at 8 a.m. on Oct. 10, 2012, is disappeared from the date column 130 of the electronic calendar 120 when the calendar item 21 (i.e., Subject1-1) has been unselected.

In one example embodiment, the subject grouping module 104 arranges the calendar events into different subject groups (according to user's requirements). Referring to FIG. 4, the calendar events including Subject1-1, Subject1-2, and Subject1-3 are arranged into a meeting group, for example Group1, and the calendar event including Subject2-1 is arranged into a company group, for example Group1. Each of the subject groups includes an addition button 22 that is used to add calendar events to the subject group.

The subject selecting module 105 determines whether each of the subject groups includes more than one calendar events. If the subject group includes more than one calendar events, the subject selecting module 105 displays a full selection button 23 on the schedule operational menu 2 of the electronic calendar 120.

The setting module 106 displays a setting button 24 for each of the calendar items 21 on the schedule operational menu 2. The setting button 24 can be used to set a front color for the calendar item 21, and set a subject name for each of the calendar events.

The subject adding module 107 displays a management button 25 on the schedule operational menu 2. The schedule operational menu 2 can be used to add a new subject group to the schedule operational menu 2.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer-readable program comprising instructions that, which when executed by the at least one processor, causes the at least one processor to:
generate a schedule operational menu in an electronic calendar of the electronic device, the schedule operational menu comprising a plurality of calendar items;
search subject information of a calendar event from the storage device when one of the calendar items is selected;
determine a date of the calendar event in the electronic calendar;
display the subject information of the calendar event on a date column of the electronic calendar; and
hide the subject information of the calendar event from the date column of the electronic calendar when the calendar item is unselected.

2. The electronic device according to claim 1, wherein the schedule operational menu further comprises a plurality of check boxes, and each of the calendar items comprises a calendar event that corresponds to a check box.

3. The electronic device according to claim 1, wherein the computer-readable program further causes at least one processor to:
arrange each of the calendar events into different subject groups;
determine whether each of the subject groups includes more than one calendar events; and
display a full selection button on the schedule operational menu of the electronic calendar if the subject group includes more than one calendar events.

4. The electronic device according to claim 1, wherein the computer-readable program further causes at least one processor to display a setting button for each of the calendar items on the schedule operational menu.

5. The electronic device according to claim 4, wherein the setting button is used to set a front color for the calendar item and a subject name for each of the calendar events.

6. The electronic device according to claim 1, wherein the computer-readable program further causes at least one processor to display a management button for adding a new subject group to the schedule operational menu.

7. A method for scheduling calendar events in an electronic calendar, the method comprising:
generating, at an electronic device, a schedule operational menu in the electronic calendar, the schedule operational menu comprising a plurality of calendar items;
searching, at the electronic device, subject information of a calendar event when one of the calendar items is selected;
determining a date of the calendar event in the electronic calendar;
displaying, at the electronic device, the subject information of the calendar event on a date column of the electronic calendar; and
hiding, at the electronic device, the subject information of the calendar event from the date column of the electronic calendar when the calendar item is unselected.

8. The method according to claim 7, wherein the schedule operational menu further comprises a plurality of check boxes, and each of the calendar items comprises a calendar event that corresponds to a check box.

9. The method according to claim 7, further comprising:
arranging each of the calendar events into different subject groups;
determining whether each of the subject groups includes more than one calendar events; and
displaying a full selection button on the schedule operational menu of the electronic calendar if the subject group includes more than one calendar events.

10. The method according to claim 7, further comprising: displaying a setting button for each of the calendar items on the schedule operational menu.

11. The method according to claim 10, wherein the setting button is used to set a front color for the calendar item and a subject name for each of the calendar events.

12. The method according to claim 7, further comprising: displaying a management button for adding a new subject group to the schedule operational menu.

13. A non-transitory storage medium having stored thereon instructions that, when executed by at least one processor of an electronic device, causes the least one processor to perform a method for scheduling calendar events in an electronic calendar of the electronic device, the method comprising:
generating a schedule operational menu in the electronic calendar, the schedule operational menu comprising a plurality of calendar items;
searching, at the electronic device, subject information of a calendar event when one of the calendar items is selected;
determining a date of the calendar event in the electronic calendar;
displaying, at the electronic device, the subject information of the calendar event on a date column of the electronic calendar; and
hiding, at the electronic device, the subject information of the calendar event from the date column of the electronic calendar when the calendar item is unselected.

14. The storage medium according to claim 13, wherein the schedule operational menu further comprises a plurality of check boxes, and each of the calendar items comprises a calendar event that corresponds to a check box.

15. The storage medium according to claim 13, wherein the method further comprises:
arranging each of the calendar events into different subject groups;
determining whether each of the subject groups includes more than one calendar events; and
displaying a full selection button on the schedule operational menu of the electronic calendar if the subject group includes more than one calendar events.

16. The storage medium according to claim 13, wherein the method further comprises:
displaying a setting button for each of the calendar items on the schedule operational menu.

17. The storage medium according to claim 16, wherein the setting button is used to set a front color for the calendar item and a subject name for each of the calendar events.

18. The storage medium according to claim 13, wherein the method further comprises:
displaying a management button for adding a new subject group to the schedule operational menu.
